(19) United States
(12) Patent Application Publication
(10) Pub. No.: US 2014/0284399 A1
(43) Pub. Date: Sep. 25, 2014

(54) INJECTION MOLDING NOZZLE WITH TWO-PART MATERIAL PIPE

(71) Applicant: GUENTHER HEISSKANALTECHNIK GMBH, Frankenberg (DE)

(72) Inventors: Herbert GÜNTHER, Allendorf (DE); Siegrid SOMMER, Burgwald (DE); Torsten SCHNELL, Lichtenfels (DE)

(73) Assignee: GUENTHER HEISSKANALTECHNIK GMBH, Frankenberg (DE)

(21) Appl. No.: 14/221,358

(22) Filed: Mar. 21, 2014

(30) Foreign Application Priority Data
Mar. 21, 2013 (DE) 10 2013 102 925.6

(51) Int. Cl. B29C 45/20

(52) U.S. Cl. CPC B29C 45/20
USPC 239/132

(57) ABSTRACT

It is the object of the present invention to improve as to how heat is introduced into the tip of an injection molding nozzle.

To this end, the invention provides an injection molding nozzle comprising a material pipe that forms a flow channel with an inlet opening and an outlet opening, as well as a heating device that is thermally coupled to the material pipe, and the material pipe includes two pipe sections that are connected to each other at a coupling location, and wherein the inlet opening is disposed on the first pipe section and the outlet opening is disposed on the second pipe section, and wherein the second pipe section is made of a material of higher thermal conductivity than the first pipe section.

The invention relates to an injection molding nozzle according to the preamble of claim 1.

Injection molding nozzles, particularly hot-channel- or cold-channel-type nozzles, are generally known in the art. They are used in injection molding tools for supplying a free-flowing mass at a predeterminable temperature and under high pressure to a tool block (mold cavity), which can be separated. An electric heating device, as disclosed in DE 295 01 450 U1, is provided to avoid that a hot plastic molding compound cools prematurely while inside the nozzle, and wherein the electric heating device surrounds a material pipe with a flow channel configured therein in a concentric manner. The goal herein is to maintain the liquid plastic material at the desired temperature. A temperature sensor is used for detecting and controlling the temperature.

The material pipe and the heating device are usually designed as separate structural elements; this way, it is possible to replace the heating device in the event that it becomes defective. The actual heating element, an electric resistor, is integrated therein, together with the temperature sensor, inside a jacket. This jacket is circumferentially plugged onto the material pipe. The jacket can have a rigid structure, such as disclosed, for example, in DE 89 15 318 U1, DE 295 07 848 U1 or U.S. Pat. No. 4,558,210, which can be mounted on the material pipe in the axial direction by retaining and/or bracing elements. Also possible is the use of flexible heating strips and/or mats that are fixed in place on the external circumference of the material pipe (see EP 0 028 153 B1 or WO 97/03540).

As a substantial disadvantage, these heating devices, which are generally mechanically detachable, suffer from a, for the most part, minimally efficient heat transfer from the heating device to the material pipe. Particularly in the area of the tip of the nozzle, which comes closest to the cold side of the tool, meaning the mold plate, the heating device is often not able to provide the necessary temperature input. Correspondingly, the temperature distribution that is present over the length of the material pipe is not linear, which, in turn, can negatively influence the quality of the parts that must be manufactured. A sufficient power density, and thereby even temperatures at the tip of the nozzle, can only be achieved with relatively great technical complexity.

The prior art provides ways for improving how heat is introduced into nozzle mouthpieces that are inserted in the nozzle tip. For example, DE 10 2009 025 164 A1 proposes integrating a highly thermally conducting element made of a pyrolytic graphite into the mouthpiece of the nozzle. However, nozzle mouthpieces of this kind are very expensive. In addition, the design freedom is quite limited, because, due to the crystalline structure thereof, pyrolytic graphite conducts heat only in a single linear axial direction. Moreover, problems also result from the minimal solidity and poor processing properties of graphite.

Therefore, it is the object of the present invention to overcome these and other disadvantages of the prior art and to provide an injection molding nozzle for an injection molding tool that offers a high level of heat transfer in the area of the nozzle tip from the heating device to the material pipe and/or to the fluidized material mass that flows through the mouthpiece of the nozzle. It is the object of the present invention to provide an injection molding nozzle that can be manufactured cost-effectively, with simple means, and that can be quickly assembled.

The main characterizing features of the invention are disclosed in the characterizing portion of claim 1. Embodiments that are derived therefrom are the subject-matter of claims 2 to 16.

The invention relates to an injection molding nozzle comprising a material pipe that represents a flow channel with an inlet opening and an outlet opening, as well as a heating device that is thermally coupled to the material pipe, wherein the material pipe includes two pipe sections that are connected to each other at a coupling location, and wherein the inlet opening is disposed on the first pipe section, and the outlet opening is disposed on the second pipe section, and wherein the second pipe section is made of a material having higher thermal conductivity than that of the first pipe section.

The advantage of the material choice according to the invention lies in the fact that the section of the injection molding nozzle that is critical in terms of the temperature, which is, in fact, the section of the material pipe in the area of the outlet opening, is able to transfer heat particularly fast and efficiently from the heating device to the fluidized material mass flowing through the pipe, which is particularly a plastic material. Due to the fast heat dissipation, it is possible to achieve a higher thermal output of the heating device in this area, without the heating device burning through. Possible additional material costs can be limited to the second pipe section. The configuration according to the invention makes is further possible to thermally couple the heating device to the second pipe section directly, particularly by a two-dimensional contact between the heating device and the second pipe section. It is possible to thus avoid a reduced heating output, as in the prior art, where heat is only transferred indirectly via the material pipe to a mouthpiece of the nozzle with better thermal conductivity.

An embodiment of the present invention that is cost-effective and practically expedient provides that the first pipe section is made of tool steel, particularly tool steel with a high chromium content part. According to a special variant, the second pipe section is made of a molybdenum alloy and/or titanium and/or zirconium, particularly titanium-zirconium-molybdenum. Higher material costs and increased processing complexities are limited solely to the second pipe section.

For most applications of use, a more detailed embodiment of the first pipe section calls for including a nozzle head on the side of the inlet opening. Using such a nozzle head, the injection molding nozzle can be fixed in place, specifically in a sealing manner, on a distributor or a machine nozzle. However, one-piece embodiments of the first pipe section with a distribution plate of the distributor are also conceivable.

According to an improvement of the invention, at the coupling location, the first pipe section protrudes into the second pipe section. This creates a particularly large exterior jacket surface on the second pipe section, which can be used for dissipating a correspondingly large quantity of heat from the heating device.

Moreover, one variant of the invention provides that the first pipe section has an external thread at the coupling location that engages in the internal thread of the second pipe section. Correspondingly, no further coupling means are necessary; the result is a stable, load-resistant connection between the two pipe sections. A screwed connection of this type is also very well suited for stressing the sealing surfaces of the pipe section by a press-on force.

In one special embodiment, the first pipe section has a front face sealing surface at the coupling location, and the second pipe section has a corresponding sealing surface. Sealing surfaces of this kind are suitable for connecting material pipe section to each other in a sealing manner. In particular in combination with a screwed connection, the front face sealing surface is able to withstand loads in perpendicular direction of the corresponding sealing surface. It is possible to provide a sealing ring between the sealing surfaces.

To achieve ideal flow conditions inside the flow channel, an improvement of the invention provides that the inside walls of the first and the second pipe sections are coaxially disposed relative to each other in the area of the coupling location, particularly at the location of the internal seam, and that they have the same inside diameter. From a manufacturing engineering standpoint, the inside walls are preferably configured cylindrically in the area of the coupling locations, particularly on both sides of the internal seam location.

A simple and cost-effective heating device with good heat transfer properties on the material pipe is successfully obtained, in particular, when the exterior jacket areas of the first and second pipe sections are disposed coaxially relative to each other in the area of the coupling location, particularly in the area of the exterior seam location, and when they have the same outside diameter. Preferably, the exterior jacket area is cylindrical on both sides of the exterior seam location.

To prevent static hyperdetermination and a failure of the seal between the two pipe sections, the exterior surfaces of the jacket of the first and the second pipe sections should be spaced relative to each other leaving an air gap there-between, particularly at the site of the exterior seam location. An interior seal also has the advantage that the coupling means (the threads) are disposed outside of the flow channel and are thus more easily detachable.

A particularly easy disassembly/assembly of the two pipe sections is achieved when the first pipe section has a higher thermal coefficient of expansion than the second pipe section. This is the case, in particular, when the first pipe section protrudes into the second pipe section at the coupling location. This is, in fact, when the selected coupling forces can be selected as less tight for an assembly at room temperature. Assembly damage is thus avoided. At the operating temperature of the material pipe, the coupling automatically solidifies due to the higher thermal expansion of the first pipe section.

In a further more detailed embodiment, a nozzle mouthpiece is provided in the area of outlet opening of the second pipe section. Nozzle mouthpieces influence the outflow behavior of the fluidized material from the injection molding nozzle. Depending on the sprue opening and application, the nozzle mouthpiece can be designed correspondingly, such that high-quality injection-molded parts can be produced consistently.

The nozzle mouthpiece should also be made of a material with good heat conducting properties. This is the only modality for correct temperature control of the fluidized material until the point of exit thereof from the injection molding nozzle. To achieve thermal insulation relative to the mold plate, according to an improvement of the invention, the nozzle mouthpiece carries a sealing ring, and wherein the material of the sealing ring has lower thermal conductivity than the material of the nozzle mouthpiece. Only the sealing ring therein touches in an injection molding tool the mold plate that constitutes the mold cavity, which is also referred to as the cold side of the tool. In particular, the sealing ring can be pushed or screwed onto the nozzle mouthpiece. Heat dissipation from the nozzle mouthpiece onto the mold plate is thereby, for the most part, prevented.

Particularly good thermal transfer from the heating device to the fluidized material is successfully achieved when the second pipe section is configured in one piece, particularly monolithically, with the nozzle mouthpiece.

Alternately, it is possible to insert the nozzle mouthpiece into the material pipe, clamping the same in place between the first and the second pipe sections. It is possible to manufacture the nozzle mouthpiece from a different material, such as, for example, a material offering better workability properties. In addition, in the event of demonstrated wear and tear, the nozzle mouthpiece can be easily replaced without the second pipe section. For this alternate solution, the nozzle mouthpiece should be made of a material that has a higher thermal coefficient of expansion than the second pipe section. With the higher expansion of the internally located nozzle mouthpiece, a press-fit step is achieved at operating temperature, and the heat transfer from the second pipe section to the nozzle mouthpiece particularly high. In this embodiment, the nozzle mouthpiece should constitute a sealing ring. This sealing ring can then be clamped in place between the sealing surfaces of the pipe sections. Furthermore, in this alternate solution, the nozzle mouthpiece extends at least to the point of the outlet opening of the second pipe section in order to be able to protrude into a sprue opening of a mold plate.

According to one variant of the invention, the nozzle mouthpiece includes a nozzle tip. Injection molding nozzles with such nozzle mouth pieces that cannot be closed and opened are especially compact, sturdy and cost-effective.

For special areas of application, a further variant of the invention provides, on the other hand, a needle guide element that is allocated to the nozzle mouthpiece. Such a guide element can guide a closing needle. Due to the needle guide element, the closing needle is consistently correctly aligned relative to a corresponding (in most cases cylindrical) sealing surface in the nozzle mouthpiece. This way, the flow action through of the nozzle mouthpiece is positively influenced. In particular, a radially even flow passes around a centered closing needle.

One special, more detailed embodiment provides that the needle guide element include a guide spiral. During the assembly, this spiral winds about the closing needle which is, consequently, safely guided over the total circumference thereof. Any wear on the contact surface is thereby even distributed over a large area, whereby a long operating life is provided. Moreover, a flow channel section is configured that winds around the closure needle. Linear melt orientation with connecting lines emerging at the outlet of the needle guide element between recombined melt flows is thus prevented. This results in better quality of the injection molded parts.

Furthermore, a beneficial and simple production is achieved in one improvement, where the needle guide element is inserted in the material pipe and clamped in place between the first and second pipe sections. Additional fastening means are therefore not required. The needle guide element can be produced, in addition, of a different kind of material. Moreover, the needle guide element can be replaced independently and without the second pipe section, when it is worn out. With this alternate solution, the needle guide element should be produced of a material that has a higher thermal coefficient of expansion than the second pipe section. Due to the higher expansion of the interior needle guide element, the press-on fit is achieved at operating temperature, and the heat transfer from the second pipe section to the needle guide element is especially high. The needle guide element therein should constitute a sealing ring. The same is can then be clamped in place between the sealing surfaces of the pipe sections, and, if necessary, together with the remaining nozzle mouthpiece, which is also configured as a sealing ring.

However, preferably, the needle guide element is configured in one piece, particularly monolithically, with the nozzle mouthpiece. This way, fewer parts are used, and the number of the sealing surfaces that must be processed is reduced. This is cost-effective and less susceptible for leakiness.

For the purpose of achieving good heat transfer properties to the material pipe in the area of the outlet opening, the second pipe section should have a length of at least 1.5 cm. The length of the second pipe section is preferably at least one quarter, and particularly preferred at least one third of the size, of the length of the first pipe section.

Further characteristics, details and advantages of the present invention can be derived from the specified claims and based on the following description of the embodiments based on the drawings. Shown are as follows:

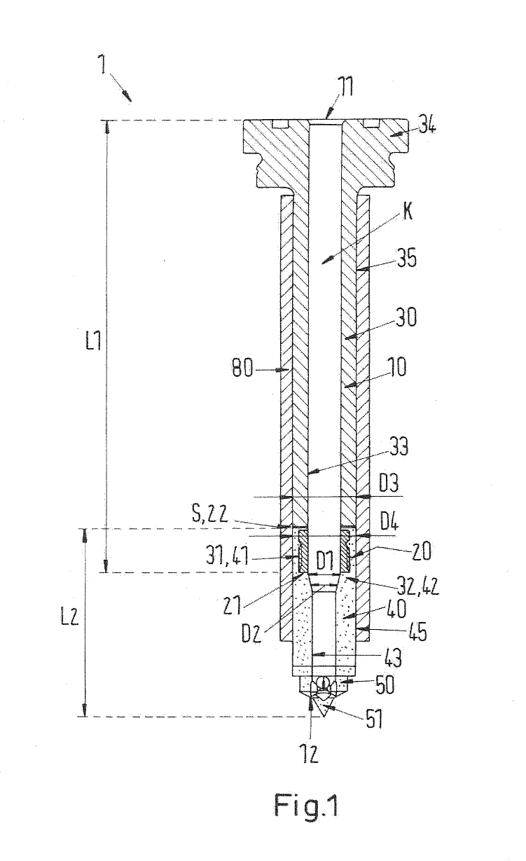

FIG. 1 is a longitudinal section of an injection molding nozzle, where a second pipe section is formed in one piece with a nozzle mouthpiece with nozzle tip;

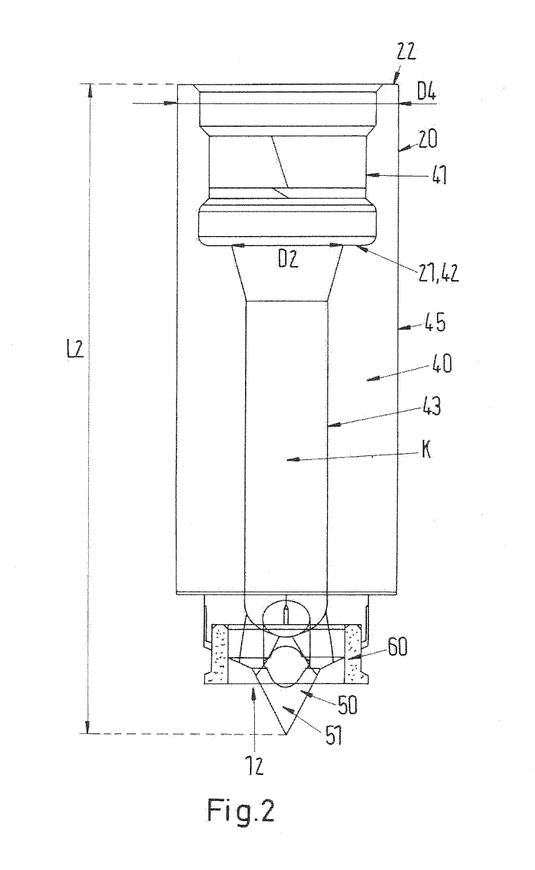

FIG. 2 is a longitudinal section of the pipe section as depicted in FIG. 1 with an additional sealing ring;

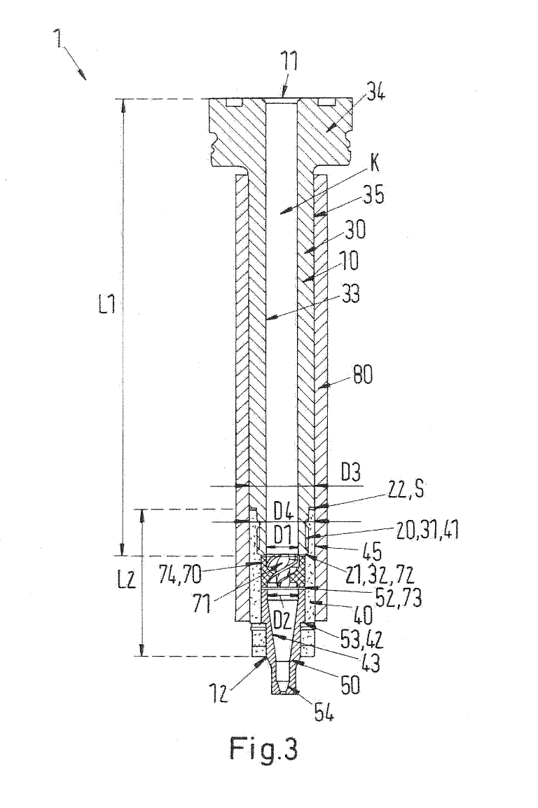

FIG. 3 is a longitudinal section of an injection molding nozzle, where a nozzle mouthpiece and a needle guide element are clamped in place between two pipe sections;

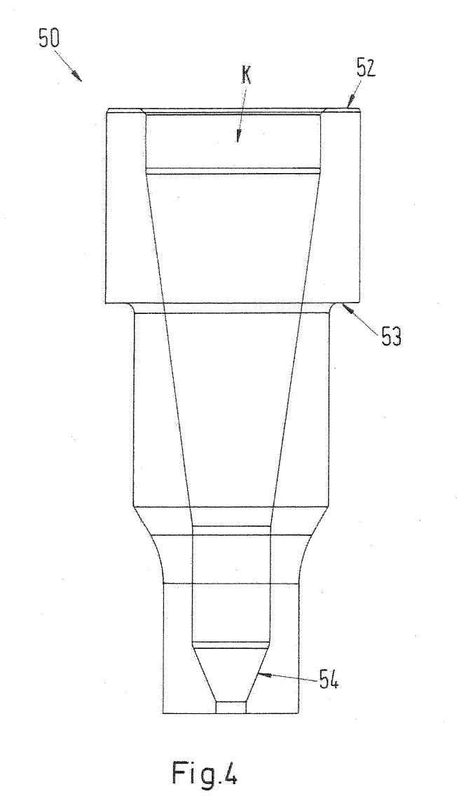

FIG. 4 is an enlarged longitudinal section of the pipe section as depicted in FIG. 3;

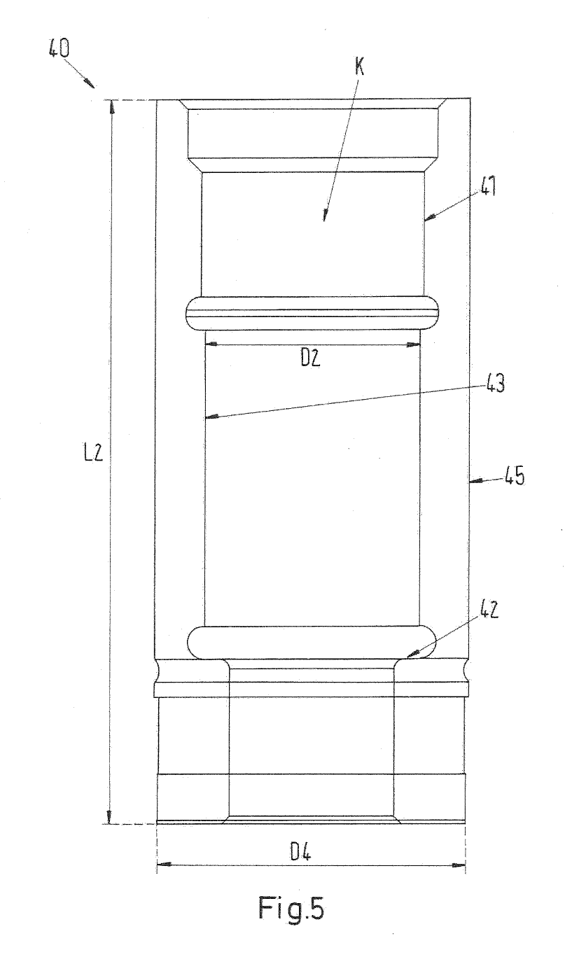

FIG. 5 is an enlarged longitudinal section of the nozzle mouthpiece as depicted in FIG. 3;

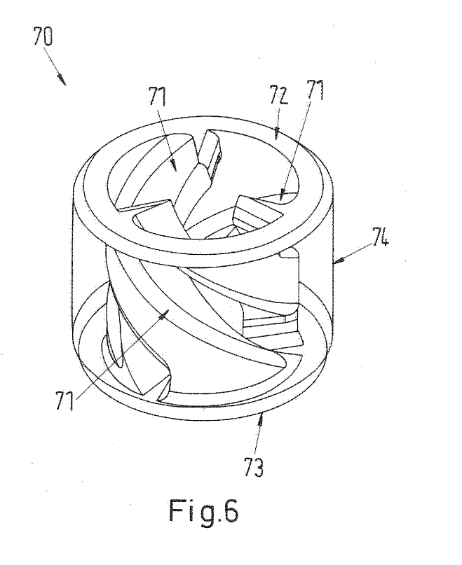

FIG. 6 is a perspective view of a needle guide element, where the exterior ring envelope is shown as transparent; and

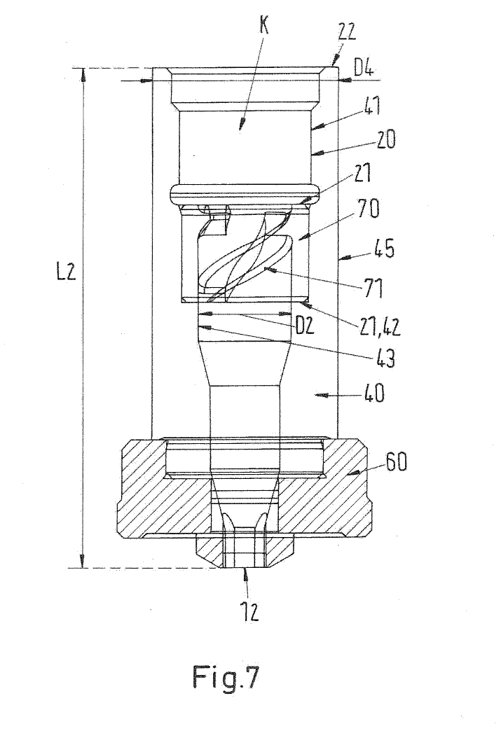

FIG. 7 is a longitudinal section of a second pipe section that is formed in one piece with the nozzle mouthpiece, and into which the needle guide element is inserted, and that carries the sealing ring.

FIGS. 1 and 3 each depict a longitudinal section of an injection molding nozzle 1. The same has a material pipe 10 that forms a flow channel K with an inlet opening 11 and an outlet opening 12. The material pipe 10 consists of a first pipe section 30 and a second pipe section 40. The two pipe sections 30, 40 are lined up at a coupling location 20 and connected to each other. The inlet opening 11 therein is disposed on the first pipe section 30 and the outlet opening 12 on the second pipe section 40. The second pipe section 40 is made of a material of a higher thermal conductivity than the first pipe section 30. In addition, the length 2 of the second pipe section 40 is, respectively, at least 25% of the length L1 of the first pipe section 30.

It can be discerned from the drawing that the first pipe section 30 has a nozzle head 34 on the side of the inlet opening 11. This nozzle head 34 serves for fixing the injection molding nozzle 1 on a distribution plate of a distributor or a machine nozzle.

At the opposite end of the first pipe section 30, at the coupling location 20, a first pipe section 30 protrudes into the second pipe section 40. In particular, the first pipe section 30 has an external thread 31 at the coupling location 20 that engages in an internal thread 41 of the second pipe section 40. The first pipe section 30 has a front face sealing surface 32 at the coupling location 20, and/or the second pipe section 40 has a directly (FIG. 1) or indirectly (FIG. 3) corresponding sealing surface 42.

The cylindrical exterior jacket coating surfaces 35, 45 of the first and the second pipe sections 30, 40 are spaced in relation to each other with an air gap S there between in order for the press-on force of the screwed connection to act upon the sealing surfaces 32, 42. The screwed connection is, in addition, particularly solid, because the first pipe section 30 has a higher thermal coefficient of expansion than the second pipe section 40.

It can also be seen that the interior wall 33, 43 of the first and the second pipe sections 30, 40 are coaxially disposed relative to each other in the area of the coupling location 20, and they have the same inside diameter D1, D2. The interior walls 33, 43 are substantially configured as cylindrically; however, in sections, they are also configured as conical.

Furthermore, the exterior jacket surfaces 35, 45 of the first and second pipe sections 30, 40 are coaxial in relation to each other in the area of the coupling location 20, and they have approximately the same outside diameter D3.

A heating device 80 is thermally coupled to the material pipe 10, particularly the first and the second pipe sections 30, 40. The heating device 80 is configured in the manner of a cuff, particularly as a heating pipe, e.g. with thick-film heater, and it is, seen from the perspective of the outlet opening 12, pushed onto the material pipe 10. The heating device therein touches the first and the second pipe sections 30, 40, particularly the exterior jacket surfaces 35, 45 thereof.

What the embodiments as shown in FIGS. 1 and 3 have in common is the fact that one nozzle mouthpiece 50 each is provided in the area of the outlet opening 12 of the second pipe section 40. However, the embodiments according to FIGS. 1 and 3 differ in terms of the design of said mouthpiece.

The nozzle mouthpiece 50 according to FIG. 1 has a nozzle tip 51 and outflow channels that are distributed around the nozzle tip 51 with radial evenness. Furthermore, the nozzle mouthpiece 50 is configured, including the nozzle tip 51, in one piece with the second pipe section 40, particularly monolithically.

The characteristics as set forth in the description regarding FIG. 1 relating to the second pipe section 40 are also identified by reference signs in FIG. 2, which shows an enlarged longitudinal section of the second pipe section 40 from FIG. 1. The representation according to FIG. 2 is supplemented, in addition, by a further sealing ring 60. This sealing ring is supported by the nozzle mouthpiece 50 and/or the second pipe section 40. Seen from the direction of the outlet opening 12, the sealing ring 60 therein is pushed onto the nozzle mouthpiece 50 and/or the second pipe section 40 and inserted into a gap in the nozzle mouthpiece 50 and/or the second pipe section 40 that is open on the front face. As an alternate solution, pressing into place, inserting, welding or soldering into place is also conceivable as fastening modalities. The sealing ring 60 is made of a material of a lower thermal conductivity than the material of the nozzle mouthpiece 50.

On the other hand, the nozzle mouthpiece 50 according to FIG. 3 has a needle guide element 70 allocated thereto, which serves for accommodating and guiding a closing needle. First, the nozzle mouthpiece is inserted as a separate part into the material pipe 10, particularly the second pipe section 40, and clamped into place between the first and the second pipe sections 30, 40. An enlarged view of the nozzle mouthpiece 50 can be found in FIG. 4. An enlarged view of the second pipe section 40 is depicted in FIG. 5. The nozzle mouthpiece 50 is configured as a sealing ring between a first sealing surface 52 and a second sealing surface 53 (see FIG. 3 and FIG. 4). By the second sealing surface 53 thereof, the nozzle mouthpiece 50 in FIG. 3 rests in a sealing manner on the internal sealing surface 42 of the second pipe section 40. To this end, the nozzle mouthpiece 50 is pushed, coming from the direction of the coupling location 20, into the second pipe section 40. The nozzle mouthpiece 50 extends beyond the outlet opening 12 of the second pipe section 40. The flow channel K, which extends through the nozzle mouthpiece 50, tapers in the direction of flow and has at the end side thereof a cylindrical needle sealing surface 54.

In addition to the actual nozzle mouthpiece 50, a needle guide element 50, as depicted by way of an enlargement in FIG. 6, is, shown from the direction of the coupling location 20, pushed into the second pipe section 40. This element consists of a sleeve 74 and guide spirals 71, which are disposed inside the sleeve, particularly three of them. The sleeve 72 is configured as a sealing ring with a first sealing surface 72 and second sealing surface 73. In the structural assembly according to FIG. 3, the first sealing surface 72 rests against the front face sealing surface 32 of the first pipe section 30. On the opposite side, the second sealing surface 73 of the needle guide element 70 forms a seal with the first sealing surface 52 of the nozzle mouthpiece 50.

The embodiment according to FIG. 7 differs from the embodiments as shown in FIGS. 3 to 6 in that the second pipe section 40 is configured as one piece, particularly monolithically, with the nozzle mouthpiece 50. The needle guide element 70 is inserted in the second pipe section 40, as in FIG. 3. A further difference of the embodiment according to FIG. 7 is the additional sealing ring 60. This sealing ring is supported by the nozzle mouthpiece 50 and/or the second pipe section 40. The sealing ring 60 therein is pushed onto the nozzle mouthpiece 50 and/or the second pipe section 40, from the direction of the outlet opening 12. The connection between the sealing ring 60 and the nozzle mouthpiece 50 and/or the second pipe section 40 can be implemented as a screwed, press, plug, welded or soldered connection. The used material has a lower thermal conductivity than the material of the nozzle mouthpiece 50.

The present invention is not limited to the previously described embodiments; it can be varied in many different ways.

For example, inter alia, the sealing ring that is depicted in FIG. 2 can easily be mounted on the injection molding nozzle according to FIG. 1. Similarly, a sealing ring according to FIG. 7 can be combined with the embodiment according to a FIG. 3.

Furthermore, the needle guide element in the embodiment according to FIG. 3 can also be configured in one piece with the nozzle mouthpiece. Moreover, as an alternate or additional option, it is also possible to configure the needle guide element according to the embodiment as shown in FIG. 7 in one piece with the pipe section.

Finally, instead of the nozzle mouthpiece and the needle guide element, as depicted in FIG. 3, it is also possible to insert the nozzle mouthpiece by a nozzle tip (corresponding to FIG. 1 or 2) into the material pipe.

The totality of the characterizing features and advantages, including the structural details, spatial arrangements and method steps can be essential for the implementation of the present invention either independently or in combinations of variable nature.

List of Reference Signs

| | |
|---|---|
| 1 | Injection molding nozzle |
| 10 | Material pipe |
| 11 | Inlet opening |
| 12 | Outlet opening |
| 20 | Coupling location |
| 21 | Internal seam location |
| 22 | External seam location |
| 30 | First pipe section |
| 31 | External thread |
| 32 | Front face sealing surface |
| 33 | First internal wall |
| 34 | Nozzle head |
| 35 | First exterior jacket surface |
| 40 | Second pipe section |
| 41 | Internal thread |
| 42 | Sealing surface |
| 43 | Second internal wall |
| 45 | Second external jacket surface |
| 50 | Nozzle mouthpiece |
| 51 | Nozzle tip |
| 52 | First sealing surface |
| 53 | Second sealing surface |
| 54 | Needle sealing surface |
| 60 | Sealing ring |
| 70 | Needle guide element |
| 71 | Guide coil |
| 72 | First sealing surface |
| 73 | Second sealing surface |
| 74 | Sleeve |
| 80 | Heating device |
| D1 | First inside diameter |
| D2 | Second inside diameter |
| D3 | First outside diameter |
| D4 | Second outside diameter |
| K | Flow channel |
| L1 | Length (first pipe section) |
| L2 | Length (second pipe section) |
| S | Air gap |

1. An injection molding nozzle (1), comprising a material pipe (10) that forms a flow channel (K) with an inlet opening (11) and an outlet opening (12), and a heating device (80) that is thermally coupled to the material pipe (10), characterized in that the material pipe (10) includes two pipe sections (30, 40) that are connected to each other at a coupling location (20), wherein the inlet opening (11) is disposed on the first pipe section (30), and the outlet opening (12) is disposed on the second pipe section (40), and wherein the second pipe section (40) is made of a material with higher thermal conductivity than the first pipe section (30).

2. The injection molding nozzle (1) according to claim 1, characterized in that the first pipe section (30) protrudes into the second pipe section (40) at the coupling location (20).

3. The injection molding nozzle (1) according to claim 1, characterized in that the first pipe section (30) has an external thread (31) at the coupling location that engages with the internal thread (41) of the second pipe section (40).

4. The injection molding nozzle (1) according to claim 1, characterized in that the first pipe section (30) includes a front face sealing surface (32) at the coupling location (20) and the second pipe section (40) includes a corresponding sealing surface (42).

5. The injection molding nozzle (1) according to claim 1, characterized in that the internal walls (33, 43) of the first and second pipe sections (30, 40) are coaxially disposed relative to each other in the area of the coupling location (20) and have the same internal diameter (D1, D2).

6. The injection molding nozzle (1) according to claim 1, characterized in that the exterior jacket surfaces (35, 45) of the first and the second pipe section (30, 40) are coaxially disposed in the area of the coupling location (20) and have the same external diameter (D3, D4).

7. The injection molding nozzle (1) according to claim 1, characterized in that the first pipe section (30) has a higher thermal expansion coefficient than the second pipe section (40).

8. The injection molding nozzle (1) according to claim 1, characterized in that a nozzle mouthpiece (50) is provided in the area of the outlet opening (12) of the second pipe section (40).

9. The injection molding nozzle (1) according to claim 8, characterized in that the nozzle mouthpiece (50) carries a sealing ring (60), wherein the material of the sealing ring (60) has a lower thermal conductivity than the material of the nozzle mouthpiece (50).

10. The injection molding nozzle (1) according to claim 8, characterized in that the second pipe section (40) is formed in one piece with the nozzle mouthpiece (50).

11. The injection molding nozzle (1) according to claim 8, characterized in that the nozzle mouthpiece (50) is inserted in the material pipe (10) and clamped in place between the first and second pipe section (30, 40).

12. The injection molding nozzle (1) according to claim 8, characterized in that the nozzle mouthpiece (50) includes a nozzle tip (51).

13. The injection molding nozzle (1) according to claim 8, characterized in that a needle guide element (70) is allocated to the nozzle mouthpiece (50).

14. The injection molding nozzle (1) according to claim 13, characterized in that the needle guide element (70) includes a guide spiral (71).

15. The injection molding nozzle (1) according to claim 13, characterized in that the needle guide element (70) is inserted into the material pipe (10) and clamped in place between the first and the second pipe sections (30, 40).

16. The injection molding nozzle (1) according to claim 13, characterized in that the needle guide element (70) and the nozzle mouthpiece (50) are formed in one piece.
